(19) United States
(12) Patent Application Publication
(10) Pub. No.: US 2020/0118335 A1
(43) Pub. Date: Apr. 16, 2020

(54) SYSTEM AND METHOD FOR TRAVELING WITH DRONE

(71) Applicants: LITE-ON ELECTRONICS (GUANGZHOU) LIMITED, Guangzhou (CN); Lite-On Technology Corporation, Taipei (TW)

(72) Inventors: Shou-Te Wei, Taipei (TW); Wei-Chih Chen, Taipei (TW)

(73) Assignees: LITE-ON ELECTRONICS (GUANGZHOU) LIMITED, Guangzhou (CN); Lite-On Technology Corporation, Taipei (TW)

(21) Appl. No.: 16/505,730

(22) Filed: Jul. 9, 2019

(30) Foreign Application Priority Data
Oct. 11, 2018 (CN) 201811182035.6

(51) Int. Cl. G06T 19/00; H04N 7/18; H04N 5/232; G08G 5/00; G06F 3/16; B64C 39/02

(52) U.S. Cl. CPC G06T 19/003; H04N 7/185; H04N 5/23216; G08G 5/0069; B64C 2201/146; B64C 39/024; G06T 2219/024; B64C 2201/123; G06F 3/165

(57) ABSTRACT

A system and a method for traveling with drone are provided. An electronic device rents a first drone through a rental system and controls the first drone to fly at an attraction. The first drone captures a picture of the attraction through an image capturing device. A first head mounted display displays the picture.

### CROSS-REFERENCE TO RELATED APPLICATION

This application claims the priority benefit of China application serial no. 201811182035.6, filed on Oct. 11, 2018. The entirety of the above-mentioned patent application is hereby incorporated by reference herein and made a part of this specification.

### BACKGROUND OF THE INVENTION

### 1. Field of the Invention

The invention relates to a system and a method for traveling, and more particularly, to a system and a method for traveling with drone.

### 2. Description of Related Art

With cameras extensively spread nowadays, cameras are often installed in multiple attractions for users to obtain current images of one particular attraction in real time simply by connecting to the cameras (or servers).

However, in general, because the cameras are often disposed at fixed positions, users can only view the image by a single viewing angle through the cameras disposed at the fixed positions. In other words, when viewing one attraction using the image of the camera, users are unable to move the cameras freely in order to travel around the attraction. Also, since users are also unable to obtain images of the attraction in different angles, the effect similar to “virtual tour” cannot be achieved.

### SUMMARY OF THE INVENTION

The invention proposes a system and a method for traveling with drone that can combine head mounted displays with drones to allow users who are not actually in the attraction to freely operate the drones to fly at the attraction and view images of the attraction, so as to achieve a more realistic virtual tour.

The invention provides a system for traveling with drone. The system includes an electronic device, a server having a rental system, a first drone having an image capturing device and a first head mounted display. The electronic device rents the first drone through the rental system and controls the first drone to fly at an attraction. The first drone captures a picture of the attraction through the image capturing device. The first head mounted display displays the picture.

The invention provides a method for traveling with drone used by a system for traveling with drone. The system includes an electronic device, a server having a rental system, a first drone having an image capturing device and a first head mounted display. The method includes: renting the first drone through the rental system and controlling the first drone to fly at an attraction by the electronic device; capturing a picture of the attraction through the image capturing device by the first drone; and displaying the picture by the first head mounted display.

Based on the above, the system and the method for traveling with drone in the invention can combine the head mounted displays with the drones to allow users who are not actually in the attraction to freely operate the drones to fly at the attraction and view the images of the attraction. In addition, the invention is also able to render the drones operated by other user in the same group into the virtual character images. Moreover, when the head mounted display intends to output the volume of the speech of the other user, the volume will be gradually decreased as the distance between the drones becomes greater. With the above method, the more realistic virtual tour can be achieved.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a system for traveling with drone according to an embodiment of the invention.

FIG. 2A to FIG. 2C are schematic diagrams illustrating virtual character images according to an embodiment of the invention.

FIG. 3 is a flowchart illustrating a method for traveling with drone according to an embodiment of the invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Descriptions of the invention are given with reference to the exemplary embodiments illustrated with accompanied drawings, in which same or similar parts are denoted with same reference numerals. In addition, whenever possible, identical or similar reference numbers stand for identical or similar elements in the figures and the embodiments.

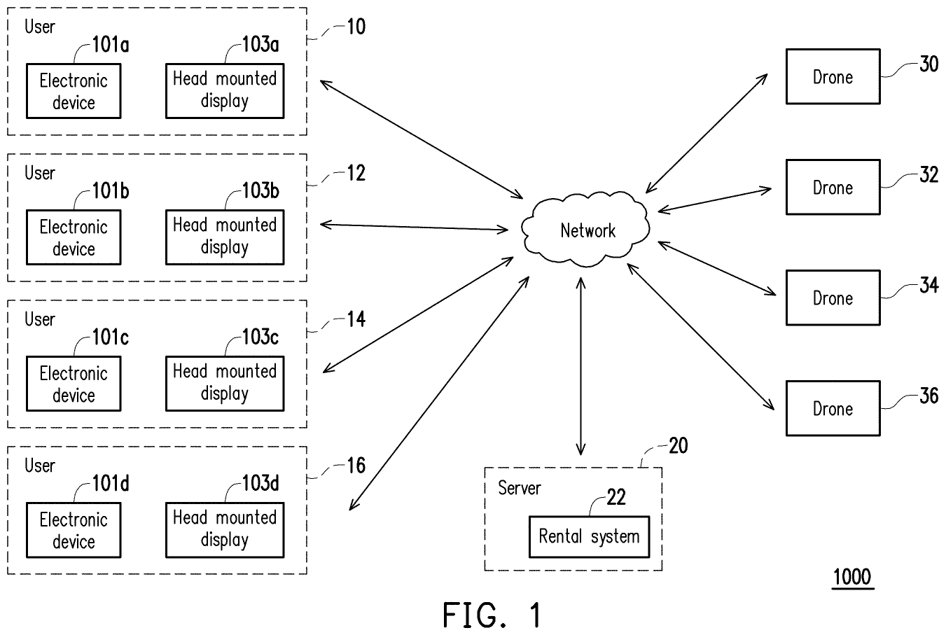

FIG. 1 is a schematic diagram illustrating a system for traveling with drone according to an embodiment of the invention.

With reference to FIG. 1, a system 1000 for traveling with drone includes electronic devices 101a to 101d, head mounted displays 103a to 103d, a server 20 and drones 30 to 36. Among them, the electronic devices 101a to 101d, the head mounted displays 103a to 103d, the server 20 and the drones 30 to 36 can perform a wired or wireless transmission with each other through a network.

Each electronic device among the electronic devices 101a to 101d in this embodiment includes a processor (not illustrated), an input circuit (not illustrated), a communication circuit (not illustrated) and a storage circuit (not illustrated). Here, each of the input circuit, the communication circuit and the storage circuit is coupled to the processor.

The processor may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements.

The input circuit may, for example, receive an input from a user through a keyboard, a mouse, a touch screen or a microphone.

The communication circuit may be a signal transmission element that supports GSM (global system for mobile communication), PHS (personal handy-phone system), a CDMA (code division multiple access) system, a WCDMA (wideband code division multiple access) system, a LTE (long term evolution) system, a WiMAX (worldwide interoperability for microwave access) system a Wi-Fi (wireless fidelity) system, Bluetooth, Wireless Gigabit Alliance (WiGig) technology or other wired signal transmission elements.

The memory circuit may be a fixed or a movable element in any possible forms including a random access memory (RAM), a read-only memory (ROM), a flash memory or other similar elements, or a combination of the above-mentioned elements.

In this exemplary embodiment, the storage circuit in each electronic device among the electronic devices 101a to 101d is stored with a plurality of program code segments. With the electronic device 101a as an example, after being installed, the program code segments in the storage circuit of the electronic device 101a will be executed by the processor of the electronic device 101a. For example, the storage circuit of the electronic device 101a includes a plurality of modules, and each operation of the electronic device 101a applied in the system 1000 will be executed by the modules, respectively. Here, each of the modules is composed of one or more program code segments. Operation of the electronic device 101b to the electronic device 101d is similar to that of the electronic device 101a, and details regarding the same are not repeated hereinafter. However, the invention is not limited in this regard. Each operation of each electronic device among the electronic devices 101a to 101d may also be implemented in other hardware manners.

In this exemplary embodiment, each head mounted display among the head mounted displays 103a to 103d may include a processor (not illustrated), a display circuit (not illustrated), a communication circuit (not illustrated), an audio input circuit (not illustrated), an audio output circuit (not illustrated) and a storage circuit (not illustrated). Here, each of the display circuit, the communication circuit, the audio input circuit, the audio output circuit and the storage circuit is coupled to the processor. The head mounted displays 103a to 103d are, for example, wearable display devices (e.g., Google glasses) for displaying virtual reality or augmented reality, but not limited thereto.

The processor, the communication circuit and the storage circuit included by each head mounted display among the head mounted displays 103a to 103d may be elements similar to the processor, the communication circuit and the storage circuit included by the electronic devices 101a to 101d, and details regarding the same are not repeated hereinafter.

The display circuits in the head mounted displays 103a to 103d are display devices capable of providing a display function in a display region of each head mounted display. The display circuit may be a display device for providing the display function, such as a LCD (liquid crystal display), a LED (light-emitting diode) display or a FED (field emission display) display.

The audio input circuits in the head mounted displays 103a to 103d may be devices or elements for obtaining a voice signal (e.g., sound), such as a microphone.

The audio output circuits in the head mounted displays 103a to 103d may be devices or elements for outputting the obtained voice signal (e.g., sound), such as a speaker.

The server 20 includes a processor (not illustrated), a communication circuit (not illustrated) and a storage circuit (not illustrated). Here, each of the communication circuit and the storage circuit is coupled to the processor.

The processor, the communication circuit and the storage circuit included by the server 20 may be elements similar to the processor, the communication circuit and the storage circuit included by the electronic devices 101a to 101d, and details regarding the same are not repeated hereinafter. Particularly, in this exemplary embodiment, the server 20 further provides a rental system for allowing the users 10 to 16 to rent the drones 30 to 36 by using the electronic devices 101a to 101d, respectively. When the drones 30 to 36 are rented by the users 10 to 16, the users 10 to 16 can respectively use the electronic devices 101a to 101d to control the drones 30 to 36 to fly at an attraction, and display images taken (or captured) by the drones 30 to 36 in the head mounted displays 103a to 103d respectively worn by the users 10 to 16, so as to achieve the virtual tour. More embodiments regarding the virtual tour of the invention will be described in detail later.

Each drone among the drones 30 to 36 includes a processor (not illustrated), a motion control circuit (not illustrated), an image capturing device (not illustrated) and a communication circuit (not illustrated). Here, each of the motion control circuit, the image capturing device and the communication circuit is coupled to the processor. The processor and the communication circuit included by the drones 30 to 36 may be elements similar to the processor and the communication circuit included by the electronic devices 101a to 101d, and details regarding the same are not repeated hereinafter.

The motion control circuit may be configured to receive a control signal, and control a flying motion of the drone based on the control signal. The motion control circuit is composed of, for example, a plurality of hardware chips and further includes a motor (not illustrated) and a control equipment (not illustrated). With the drone 30 as an example, the motor of the motion control circuit may be coupled to a propeller (not illustrated) and a control equipment of the drone 30. After receiving the control signal from the control equipment, the motor can control a speed and a torque of the propeller to thereby determine the flying motion of the drone 30.

The image capturing device is, for example, a camcorder or a camera using a charge coupled device (CCD) lens, a complementary metal oxide semiconductor transistor (CMOS) lens, or an infrared lens. In this exemplary embodiment, the image capturing device may be a panoramic camera for capturing 360-degree images.

Operations of the system 1000 of the present invention are described below with reference to various embodiments. In particular, for illustrative convenience, the following embodiments are described mainly by using the electronic device 101a, the head mounted display 103a and the drone 30 used by the user 10. Similarly, those embodiments may also be applied to the electronic devices 101b to 101d, the head mounted displays 103b to 103d and the drones 32 to 36 respectively used by the users 12 to 16.

In this exemplary embodiment, the user 10 may, for example, use the electronic device 101a to connect to a rental system 22 of the server 20 and rent the drone 30 (a.k.a. a first drone) through the rental system 22. The user may control the drone 30 to fly at the attraction that the user 10 wants to visit through the electronic device 101a. After renting the drone 30, the user 10 can wear the head mounted display 103a. The drone 30 can capture a picture of the attraction by the disposed image capturing device, and the head mounted display 103a can display the picture captured by the image capturing device of the drone 30.

In an embodiment, the drone 30 is parked at a preset location. After the electronic device 101a rents the drone 30 through the rental system 22, the drone 30 will automatically fly from the preset location to the attraction designated by the user 10, and execute an operation of allowing the user 10 to control the drone 30 to fly at the attraction through the electronic device 101a.

For instance, it is assumed that the drone 30 is initially parked at a warehouse of the owner providing the rental system 22 in Paris. If the user 10 wants to view the image around the Eiffel Tower, after the drone 30 is rented from the rental system 22 through the electronic device 101a, the drone 30 will automatically fly to a location adjacent to the Eiffel Tower, and then allow the user 10 to control the drone 30 to fly around the Eiffel Tower through the electronic device 101a. In other words, the control of the drone 30 is given to the user 10 only after the drone 30 reaches the attraction designated by the user 10.

In an embodiment, when the drone 30 flies at the designated attraction, the drone 30 flies at the attraction by a height. A position of the height is adjacent to a position of a height of the user 10 wearing the first head mounted display 103a. For example, the user 10 may enter the height of the user 10 through the electronic device 101a when renting the drone 30 from the rental system 22. Afterwards, the drone 30 may fly at the attraction according to the height input by the user 10. In this way, the images viewed by the user 10 through the head mounted display 103a may be closer to a viewing angle of the user 10 to increase the sense of presence.

In an embodiment, the drone 30 flies at the attraction only by a preset route. For instance, the preset route may be, a sidewalk and a zebra crossing. Alternatively, the preset route is, for example, a drone flight route specified by the local government of the attraction.

In an embodiment, the head mounted displays 103a to 103d may further include a first sensor (not illustrated). The first sensor may be, for example, a gravity sensor, a multi-axis accelerometer, a gyroscope, an electronic compass or similar elements. With the drone 30 controlled by the user 10 as an example, the first sensor of the head mounted display 103a senses a head turning angle of the user 10 wearing the head mounted display 103a to obtain first sensing information. The head mounted display 103a obtains a picture (a.k.a. a first picture) corresponding to the viewing angle of the user 10 from a panoramic image of the attraction captured by the drone 30. Then, the head mounted display 103a displays the first picture to be viewed by the user 10. In other words, the first picture displayed by the head mounted display 103a will change as a head portion of the user 10 swings so as to display the picture that matches the viewing angle of the user 10.

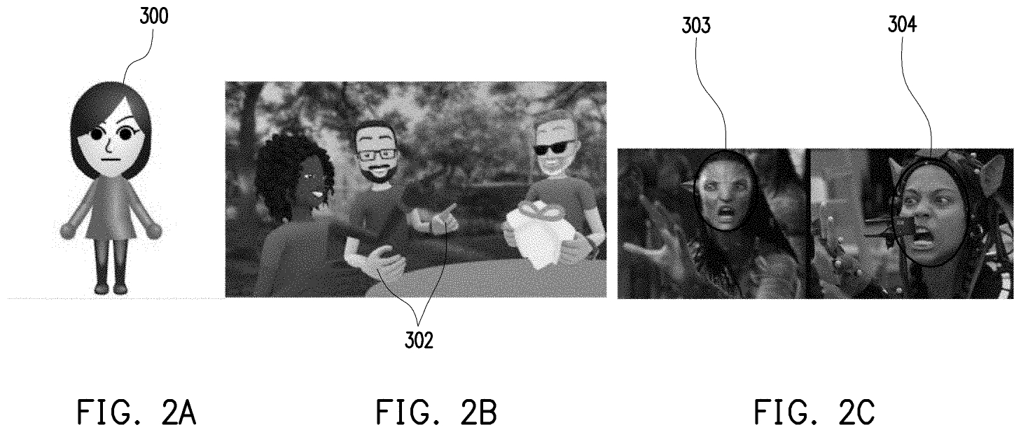

In addition, FIG. 2A to FIG. 2C are schematic diagrams illustrating virtual character images according to an embodiment of the invention. In an embodiment, part or all of the users 10 to 16 in FIG. 1 can form a virtual tour group.

With reference to FIG. 2A, it is assumed that the user 10 and the user 12 are in the same tour group and the drone 32 (a.k.a. a second drone) controlled by the user 12 through the electronic device 101b also flies at the attraction where the drone 30 is currently located. When the picture captured by the drone 30 includes the drone 32, in the picture displayed by the head mounted display 103a, the head mounted display 103a generates a picture (a.k.a. a second picture) by covering the drone 32 in the picture by a virtual character image 300 corresponding to the user 12 (a.k.a. a second user), and displays the second picture.

Particularly, in an embodiment, each of the users 10 and 12 may, for example, wear a second sensor on a hand portion of each of the users 10 and 12 for detecting a swing of each of the users 10 and 12. The second sensor may be, for example, a gravity sensor, a multi-axis accelerometer, a gyroscope, an electronic compass or similar elements. With said second picture displayed by the head mounted display 103a as an example, referring to FIG. 2B, the second sensor worn on the hand portion of the user 12 can detect the swing of the hand portion of the user 12 to obtain second sensing information. The head mounted display 103a displays the second picture according to the second sensing information such that a hand portion 302 of the virtual character image in the second picture swings according to the swinging of the hand portion of the second user.

In an embodiment, each head mounted display among the head mounted displays 103a to 103d may further include a third sensor. The third sensor is, for example, a camcorder or camera using a charge coupled device (CCD) lens, a complementary metal oxide semiconductor transistor (CMOS) lens, or an infrared lens. With said second picture displayed by the head mounted display 103a as an example, referring to FIG. 2C, the third sensor disposed on the head mounted display 103b worn by the user 12 can sense a facial expression of the user 12 to obtain third sensing information. The head mounted display 103a displays the second picture according to the third sensing information such that a facial expression 303 of the virtual character image in the second picture is identical to a facial expression 304 of the user 12.

In an embodiment, the audio input circuits of the head mounted displays 103a to 103d further obtain the sound made by each of the users 10 to 16 to generate sound signals. The audio output circuits of the head mounted displays 103a to 103d may be used to play the sound signals obtained from the audio input circuits of the other head mounted displays. More specifically, in an embodiment, it is assumed that the user 10 and the user 14 are in the same tour group. With the sound signal obtained by the head mounted display 103c and output by the head mounted display 103a as an example, when the user 14 (a.k.a. a third user) is wearing the head mounted display 103c (a.k.a. a third head mounted display) and making a sound, the audio input circuit of the head mounted display 103c worn by the user 14 may obtain the sound signal corresponding to the user 14. Then, the audio output circuit of the head mounted display 103a may output the sound signal obtained by the audio input circuit of the head mounted display 103c with a first volume. Here, a size of the first volume is inversely proportional to a first distance, and the first distance is a distance between the drone 30 and the drone 34 (a.k.a. a third drone). In an embodiment, a reciprocal of the first distance may also be used as a weight of the volume so the first volume can be obtained by multiplying the reciprocal of the first distance by a preset volume.

In particular, the users in the same tour group can learn of current locations of the drones used by each user. If the user 10 and the user 16 belong to the same tour group, the electronic device 101a of the user 10 can obtain a location of the drone (a.k.a. a fourth drone) operated by the user 16, and output the location of the drone 16. For example, the server 20 can detect and obtain the current locations of the rented drones at any time. After the fourth drone is being rent, the electronic device 101a of the user 10 can obtain information regarding the location where the fourth drone is currently located from the server 20 and output the location of the drone 16. However, it should be noted that, the invention is not intended to limit how the electronic device 101a obtains the location of the fourth drone.

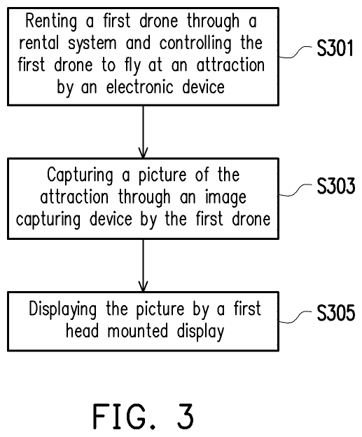

FIG. 3 is a flowchart illustrating a method for traveling with drone according to an embodiment of the invention.

With reference to FIG. 3, in step S301, an electronic device rents a first drone through a rental system and controls the first drone to fly at an attraction. In step S303, the first drone captures a picture of the attraction through an image capturing device. In step S305, a first head mounted display displays the picture.

In summary, the system and the method for traveling with drone in the invention can combine the head mounted displays with the drones to allow users who are not actually in the attraction to freely operate the drones to fly at the attraction and view the images of the attraction. In addition, the invention is also able to render the drones operated by other user in the same group as the virtual character images. Moreover, when the head mounted display intends to output the volume of the speech of the other user, the volume will be gradually decreased as the distance between the drones becomes greater. With the above method, the more realistic virtual tour can be achieved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A system for traveling with drone, comprising:
an electronic device;
a server, having a rental system;
a first drone, having an image capturing device; and
a first head mounted display device, wherein
the electronic device rents the first drone through the rental system and controls the first drone to fly at an attraction,
the first drone captures a picture of the attraction through the image capturing device, and
the first head mounted display displays the picture.

2. The system for traveling with drone according to claim 1, wherein the first head mounted display comprises a first sensor, wherein in the operation where the first head mounted display displays the picture,
the first sensor senses a head turning angle of a first user wearing the first head mounted display to obtain first sensing information, and the first head mounted display obtains a first picture corresponding to a viewing angle of the first user in the picture according to the first sensing information and displays the first picture.

3. The system for traveling with drone according to claim 1, further comprising:
a second drone, controlled by a second user, wherein in the operation where the first drone captures the picture of the attraction through the image capturing device,
when the picture includes the second drone, in the operation where the first head mounted display displays the picture, the first head mounted display generates a second picture by covering the second drone in the picture by a virtual character image corresponding to the second user and displays the second picture.

4. The system for traveling with drone according to claim 3, further comprising:
a second sensor, worn on a hand portion of the second user and configured to sense a swinging of the hand portion of the second user to obtain second sensing information, wherein in the operation where the first head mounted display displays the second picture,
the first head mounted display displays the second picture according to the second sensing information such that a hand portion of the virtual character image in the second picture swings according to the swinging of the hand portion of the second user.

5. The system for traveling with drone according to claim 3, further comprising:
a third sensor, disposed on a second head mounted display worn by the second user and configured to sense a facial expression of the second user to obtain third sensing information, wherein in the operation where the first head mounted display displays the second picture,
the first head mounted display displays the second picture according to the third sensing information such that a facial expression of the virtual character image in the second picture is identical to the facial expression of the second user.

6. The system for traveling with drone according to claim 1, wherein the first head mounted display has an audio output circuit, and the system for traveling with drone further comprises:
a third drone, controlled through another electronic device by a third user, wherein
an audio input circuit of a third head mounted display worn by the third user obtains a sound signal corresponding to the third user, and the audio output circuit of the first head mounted display outputs the sound signal with a first volume, wherein a size of the first volume is inversely proportional to a first distance, and the first distance is a distance between the first drone and the third drone.

7. The system for traveling with drone according to claim 1, wherein the system for traveling with drone further comprises:
a fourth drone, wherein
the server is configured to obtain a location of the fourth drone and output the location of the fourth drone.

8. A method for traveling with drone, used by a system for traveling with drone, the system comprising an electronic device, a server having a rental system, a first drone having an image capturing device and a first head mounted display, the method comprising:
renting the first drone through the rental system and controlling the first drone to fly at an attraction by the electronic device;
capturing a picture of the attraction through the image capturing device by the first drone; and
displaying the picture by the first head mounted display.

9. The method for traveling with drone according to claim 8, wherein after the step of renting the first drone through the rental system by the electronic device, the method further comprises:
making the first drone automatically fly from a preset location of the first drone to the attraction, and executing the operation of controlling the first drone to fly at the attraction by the electronic device.

10. The method for traveling with drone according to claim 8, wherein the step of controlling the first drone to fly at the attraction comprises:
making the first drone fly at the attraction by a height, wherein a position of the height is adjacent to a position of a height of a first user wearing the first head mounted display.

11. The method for traveling with drone according to claim 8, wherein the first head mounted display comprises a first sensor, wherein the step of displaying the picture by the first head mounted display comprises:
sensing a head turning angle of the first user wearing the first head mounted display by the first sensor to obtain first sensing information; and
obtaining a first picture corresponding to a viewing angle of the first user in the picture according to the first sensing information and displaying the first picture by the first head mounted display.

12. The method for traveling with drone according to claim 8, wherein the system for traveling with drone further comprises a second drone, and the second drone is controlled by a second user, wherein when the picture of the attraction captured through the image capturing device by the first drone includes the second drone, the step of displaying the picture by the first head mounted display comprises:
generating a second picture by covering the second drone in the picture by a virtual character image corresponding to the second user and displaying the second picture by the first head mounted display.

13. The method for traveling with drone according to claim 12, wherein the system for traveling with drone further comprises a second sensor, and the second sensor is worn on a hand portion of the second user and configured to detect a swing of the hand portion of the second user to obtain second sensing information, wherein the step of displaying the second picture by the first head mounted display comprises:
displaying the second picture according to the second sensing information by the first head mounted display such that a hand portion of the virtual character image in the second picture swings according to the swinging of the hand portion of the second user.

14. The method for traveling with drone according to claim 12, wherein the system for traveling with drone further comprises a third sensor, and the third sensor is disposed on a second head mounted display worn by the second user and configured to sense a facial expression of the second user to obtain third sensing information, wherein the step of displaying the second picture by the first head mounted display comprises:
displaying the second picture according to the third sensing information by the first head mounted display such that a facial expression of the virtual character image in the second picture is identical to the facial expression of the second user.

15. The method for traveling with drone according to claim 8, wherein the first head mounted display has an audio output circuit, the system for traveling with drone further comprises a third drone, the third drone is controlled through another electronic device by a third user, and the method further comprises:
obtaining a sound signal corresponding to the third user by an audio input circuit of a third head mounted display worn by the third user; and
outputting the sound signal with a first volume by the audio output circuit of the first head mounted display, wherein a size of the first volume is inversely proportional to a first distance, and the first distance is a distance between the first drone and the third drone.

16. The method for traveling with drone according to claim 8, wherein the system for traveling with drone further comprises a fourth drone, and the method further comprises:
obtaining a location of the fourth drone and outputting the location of the fourth drone by the server.
